(19) United States
(12) Patent Application Publication
(10) Pub. No.: US 2005/0097597 A1
(43) Pub. Date: May 5, 2005

(54) Hybrid storage of video on demand content

(76) Inventors: Leo M. Pedlow JR., Ramona, CA (US); Davender Agnihotri, Murrieta, CA (US)

Correspondence Address: MILLER PATENT SERVICES, 2500 DOCKERY LANE, RALEIGH, NC, 27606, US

(21) Appl. No.: 10/802,084

(22) Filed: Mar. 16, 2004

Related U.S. Application Data
(60) Provisional application No. 60/516,051, filed on Oct. 31, 2003.

(51) Int. Cl. H04N 7/173; H04L 9/00; H04N 7/167; H04N 7/16

(52) U.S. Cl. 725/31; 725/25; 380/200; 380/42

(57) ABSTRACT

A multiple selective encryption method for digital content consistent with certain embodiments involves selecting a plurality of packets for encryption according to a selection criterion, to produce selected packets, wherein unselected packets are designated to remain unencrypted. The plurality of selected packets is duplicated to produce duplicate packets, wherein the duplicate packets are unencrypted. The selected packets are encrypted under a first encryption system to produce first encrypted packets. The content is stored by storing the unencrypted unselected packets, the first encrypted packets and the duplicate unencrypted packets. This abstract is not to be considered limiting, since other embodiments may deviate from the features described in this abstract.

### CROSS REFERENCE TO RELATED DOCUMENTS

This application is related to and claims priority benefit of U.S. Provisional Patent Application Ser. No. 60/516,051 filed Oct. 31, 2003 to Pedlow et al. for “Hybrid Storage of Video On Demand Content” which is hereby incorporated by reference. This application is also related to U.S. Patent Applications docket number SNY-R4646.01 entitled “Critical Packet Partial Encryption” to Unger et al., Ser. No. 10/038,217; patent applications docket number SNY-R4646.02 entitled “Time Division Partial Encryption” to Candelore et al., Ser. No. 10/038,032; docket number SNY-R4646.03 entitled “Elementary Stream Partial Encryption” to Candelore, Ser. No. 10/037,914; docket number SNY-R4646.04 entitled “Partial Encryption and PID Mapping” to Unger et al., Ser. No. 10/037,499; and docket number SNY-R4646.05 entitled “Decoding and Decrypting of Partially Encrypted Information” to Unger et al., Ser. No. 10/037,498 all of which were filed on Jan. 2, 2002 and are hereby incorporated by reference herein.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The Passage™ initiative (Passage is a trademark of Sony Electronics Inc.), promoted by Sony, provides a mechanism for MSOs (Multiple Service Operators) to deploy non-legacy headend equipment, subscriber devices and services on their existing legacy networks. At present, in the USA, these networks are most commonly supplied by either Motorola (formerly General Instrument) or Scientific Atlanta. These two companies at present constitute better than a 99% share of the US cable system market as turnkey system providers. The systems, by design, employ proprietary technology and interfaces precluding the introduction of non-incumbent equipment into the network. An MSO, once choosing one of these suppliers during conversion from an analog cable system to a digital cable system, faces a virtual monopoly when seeking suppliers for additional equipment as their subscriber base or service offering grows.

Before the Passage™ initiative, the only exit from this situation was to forfeit the considerable capital investment already made with the incumbent provider, due to the intentional incompatibility of equipment between the incumbent and other sources. One primary barrier to interoperability is in the area of conditional access (CA) systems, the heart of addressable subscriber management and revenue collection resources in a modern digital cable network.

The Passage™ technologies were developed to allow the independent coexistence of two or more conditional access systems on a single, common plant. Unlike other attempts to address the issue, the two systems operate with a common transport stream without any direct or indirect interaction between the conditional access systems. Some of the basic processes used in these technologies are discussed in detail in the above-referenced pending patent applications.

The above-referenced commonly owned patent applications, and others, describe inventions relating to various aspects of methods generally referred to herein as partial encryption or selective encryption, consistent with certain aspects of Passage™. More particularly, systems are described therein wherein selected portions of a particular selection of digital content are encrypted using two (or more) encryption techniques while other portions of the content are left unencrypted. By properly selecting the portions to be encrypted, the content can effectively be encrypted for use under multiple decryption systems without the necessity of encryption of the entire selection of content. In some embodiments, only a few percent of data overhead is consumed to effectively encrypt the content using multiple encryption systems. This results in a cable or satellite system being able to utilize Set-top boxes (STB) or other implementations of conditional access (CA) receivers (subscriber terminals) from multiple manufacturers in a single system—thus freeing the cable or satellite company to competitively shop for providers of Set-top boxes.

In each of these disclosures, the clear content is identified using a primary Packet Identifier (PID). A secondary PID (or shadow PID) is also assigned to the program content. Selected portions of the content are encrypted under two (or more) encryption systems and the encrypted content transmitted using both the primary and secondary PIDs (one PID or set of PIDs for each encryption system). The so-called legacy STBs operate in a normal manner decrypting encrypted packets arriving under the primary PID and ignoring secondary PIDs. The newer (non-legacy) STBs operate by associating both the primary and secondary PIDs with a single program. Packets with a primary PID are decoded normally and packets with a secondary PID are first decrypted then decoded. The packets associated with both PIDs are then assembled together to make up a single program stream. The PID values associated with the packets are generally remapped to a single PID value for decoding (e.g., shadow PIDs remapped to the primary PID value or vice versa.)

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of a clear video VOD system.

FIG. 2 is a diagram illustrating storage of I-frame data to support trick mode operation in a VOD system.

FIG. 3 is a block diagram of a pre-encrypted VOD system using a single (legacy) encryption system.

FIG. 4 is a block diagram depicting a hybrid composite VOD system architecture consistent with certain embodiments of the present invention.

FIG. 5 is a flow chart of a storage and retrieval process consistent with certain embodiments of the present invention.

### ACRONYMS, ABBREVIATIONS AND DEFINITIONS

ASI—Asynchronous Serial Interface
CA—Conditional Access
CASID—Conditional Access System Identifier
CPE—Customer Premises Equipment
DHEI—Digital Headend Extended Interface
ECM—Entitlement Control Message
EPG—Electronic Program Guide
GOP—Group of Pictures (MPEG)
MPEG—Moving Pictures Experts Group
MSO—Multiple System Operator
PAT—Program Allocation Table
PID—Packet Identifier
PMT—Program Map Table
PSI—Program Specific Information
QAM—Quadrature Amplitude Modulation
RAID—Redundant Array of Independent Disks
RAM—Random Access Memory
SAN—Storage Area Network
VOD—Video on Demand
Critical Packet—A packet or groups of packets that, when encrypted, renders a portion of a video image difficult or impossible to view if not properly decrypted, or which renders a portion of audio difficult or impossible to hear if not properly decrypted. The term “critical” should not be interpreted as an absolute term, in that it may be possible to hack an elementary stream to overcome encryption of a “critical packet”, but when subjected to normal decoding, the inability to fully or properly decode such a “critical packet” would inhibit normal viewing or listening of the program content.
Selective Encryption (or Partial Encryption)—encryption of only a portion of an elementary stream in order to render the stream difficult or impossible to use (i.e., view or hear).
Dual Selective Encryption—encryption of portions of a single selection of content under two separate encryption systems.
Passage™—Trademark of Sony Electronics Inc. for various single and multiple selective encryption systems, devices and processes.
Trick mode—an operational mode of playback of digital content to simulate fast forward, rewind, pause, suspend (stop), slow motion, etc. operations as in a video tape system.

The terms “a” or “an”, as used herein, are defined as one, or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The terms “scramble” and “encrypt” and variations thereof may be used synonymously herein. Also, the term “television program” and similar terms can be interpreted in the normal conversational sense, as well as a meaning wherein the term means any segment of A/V content that can be displayed on a television set or similar monitor device. The term “storing” as used herein means both the act of placing data into a storage medium and holding the data in storage in the storage medium. The term “video” is often used herein to embrace not only true visual information, but also in the conversational sense (e.g., “video tape recorder”) to embrace not only video signals but associated audio and data. The term “legacy” as used herein refers to existing technology used for existing cable and satellite systems. The exemplary embodiments of VOD disclosed herein can be decoded by a television Set-Top Box (STB), but it is contemplated that such technology will soon be incorporated within television receivers of all types whether housed in a separate enclosure alone or in conjunction with recording and/or playback equipment or Conditional Access (CA) decryption module or within a television set itself.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts ein the several views of the drawings.

Clear VOD Architectures

The decision on a particular VOD architecture is the result of the interaction between a complex set of both independent and dependent variables, providing a solution to an equation of state. Some of the variables are fixed directly as a result of choices by the MSO. Others are constrained by factors such as the existing incumbent system, location, size, available capital and ROI requirements.

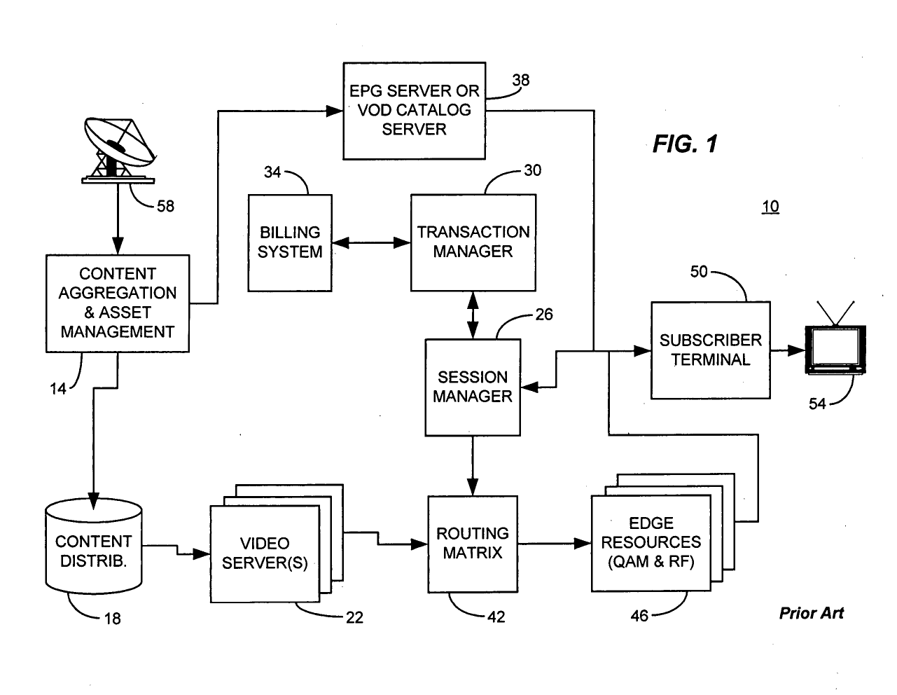

A generalized VOD system 10, as shown in FIG. 1, contains some or all of the following elements/resources: Content Aggregation and Asset management 14, Content distribution (SAN) 18, Video server module(s) 22, Session Management 26, Transaction management 30, Billing system 34, EPG server or VOD catalog server 38, Transport router/switch fabric (routing matrix) 42, Stream encryption device(s) (not shown in this Figure), and QAM modulators/upconverters and other edge resources 46. This VOD system 10 provides programming to the subscriber terminals such as 50 for ultimate viewing and listening on a TV set or other monitor device 54.

In operation, content is received from various sources including, but not limited to, satellite broadcasts received via one or more satellite dishes 58. Content is aggregated at 14 and cataloged at EPG server or VOD catalog server 38. Content is then distributed at 18 to one or more video servers 22. When a subscriber orders a VOD selection, a message is sent from the subscriber terminal (e.g., STB) 50 to the session manager 26. The session manager 26 notifies the transaction manager 30 to assure that the billing system 34 is properly brought into play. The session manager 26 selects a VOD server from a cluster of VOD servers having the requested content on it and having a signal path that reaches the node serving the subscriber. The session manager 26 also enables the routing matrix 42 to properly route the selected video content through the correct edge resources 46 for delivery to the subscriber terminal 50.

Trick Modes

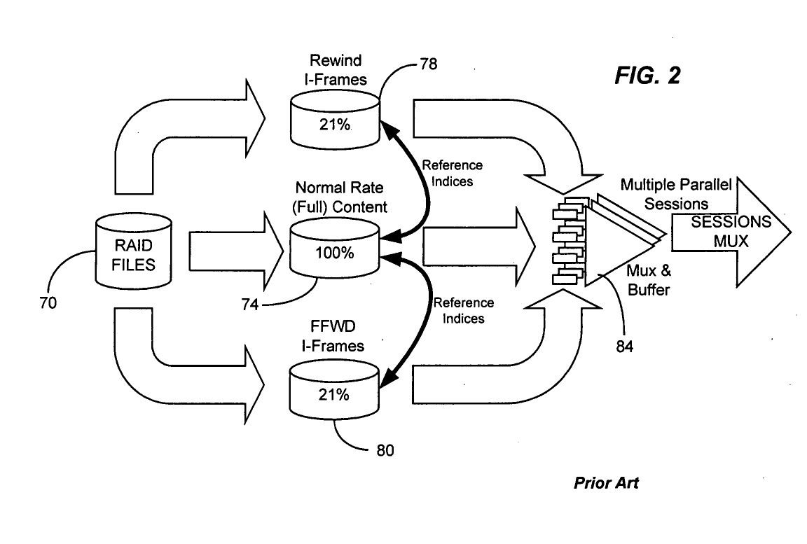

One aspect of VOD that has become a “signature” feature is the support of “trick modes”. These are operational modes invoked by the session client that mimic a traditional VCR or DVD player and includes fast forward, rewind, pause, suspend (stop), slow motion, etc. Trick modes have been heretofore implemented through the creation of multiple files containing a subset of the original content (subfiles) as illustrated in FIG. 2. The content is generally stored in a set of RAID drives 70. A particular selection of content is stored in its entirety in a file 74 within the RAID drives 70. A set of subfiles for rewind and fast forward trick modes (files 78 and 80 respectively) contain I-frames ordered in a manner that will permit playback sequentially to achieve the rewind and fast forward effect. Typically, these subfiles contain only I-frames, since I-frames contain stand-alone whole pictures (see ISO/IEC 13818-2, section 6.1.1.7). I-frames are somewhat larger than B or P frames, and they typically represent approximately as much as 21% of the data in a given video selection.

A file containing only I-frames extracted from the original content affords the ability to have accelerated playback, since typical GOP (group of pictures) structures have only one frame in about 10 to 20 as an I-frame. If the I-frame files are played at normal rates (1 frame per 33 mS) the pictures will appear to the viewer to sequence at about a 10× to 20× rate, though the actual data rate is the same as the original content. If the I-frame sequence is reversed in the file, the motion will appear to run backwards. This is the method used to implement fast forward and rewind trick modes.

By attaching an index count to match the I-frames in the original content file to the duplicated I-frames stored in the associated subfiles 78 and 80, a method is provided to allow immediate transition from normal speed forward play to fast forward or rewind. In operation the video server plays the selected content file and upon subscriber selection of a trick mode (or vice versa) the server notes the index value of the closest I-frame and then opens the appropriate associated subfile 78 or 80 and moves to the I-frame in the subfile with the same corresponding index. The video server treats all stream content (main file or subfiles) the same and always spools the MPEG packets to the outgoing transport stream at the same constant bit rate through multiplexers and buffers 84 as shown. It is through this method that trick modes are typically implemented on a slotted, session based system without the encumbrance of additional, dynamic bit rate issues.

Unfortunately, the use of such multiple subfiles results in storage space inefficiencies. As will be seen, these inefficiencies can become compounded in systems utilizing multiple encryption.

VOD Program Specific Information

A function of the VOD video server(s) 22, in addition to origination of session A/V content, is the creation of the associated, session specific PSI (program specific information). This information is a departure from the broadcast model in that the PSI is extremely dynamic. The content of the PAT and subordinate PMTs change whenever a new session is started or ended. In the broadcast world, the PSI changes very seldom because the PSI tables reflect only the structure of the transport multiplex, not the actual A/V content carried within.

The VOD video server 22 dynamically assigns a new session to an existing, available “slot” in an outgoing transport multiplexed stream. The slot is denoted by the MPEG program number and in many cases, the combination of which transport stream (TSID) and program number determine at the service level a unique session and the routing that occurs as a result. Edge resources 46 generally are not configured dynamically. The routing of content appearing on a particular input port to a specific QAM carrier at the output is determined through a preconfigured, static assignment of TSID/input port and program number mapping to specific QAM resources in the device. This same mapping information is also loaded in the VOD system so that once a session is requested by and authorized for a specific subscriber terminal 50, a solution to a routing matrix 42 can be determined to find the appropriate VOD server 22 and QAM transport 46 serving the requestor. This solution also considers dynamic issues such as which servers 22 the requested asset is loaded upon, and server loading/available slots in addition to the simpler, static solution to finding the first possible path to the requesting subscriber terminal 50.

In addition to solving the routing matrix 42 and provisioning the session with PIDs and PSI appropriate to follow the intended route, elements of the same information (program ID and QAM frequency) are also communicated to the session client at subscriber terminal 50 at the subscriber's premises so that the requested stream can be properly received and presented to the subscriber.

Clear VOD Distribution

Perhaps the simplest VOD distribution system implementation is a clear VOD distribution system, i.e. one that contains no encryption as depicted in FIG. 1. While not providing any safekeeping of what might be considered the entertainment medium's most valuable properties, namely current feature films, etc., clear VOD avoids many of the issues that the incumbent cable system providers to date have not adequately addressed and that introduction of a second, alternative CA system complicates even further still. Various arrangements for providing selective or full encryption in a VOD environment are discussed below. Throughout this discussion, it is instructive to carry an example VOD movie through the various embodiments to illustrate the relative storage efficiencies obtained with the various systems disclosed. A real world example of a VOD movie which will be used throughout this document has the following attributes:

| | |
|---|---|
| Compressed video data rate: | 3 Mbit/S |
| Movie length: | 120 minutes (2 Hrs) |
| I-frame overhead: | 17% |
| Total storage used for | |
| the video portion of a | |
| single, clear (unencrypted) | |
| copy of a film: | 3.618 GBytes. |

Pre-Encrypted VOD Distribution

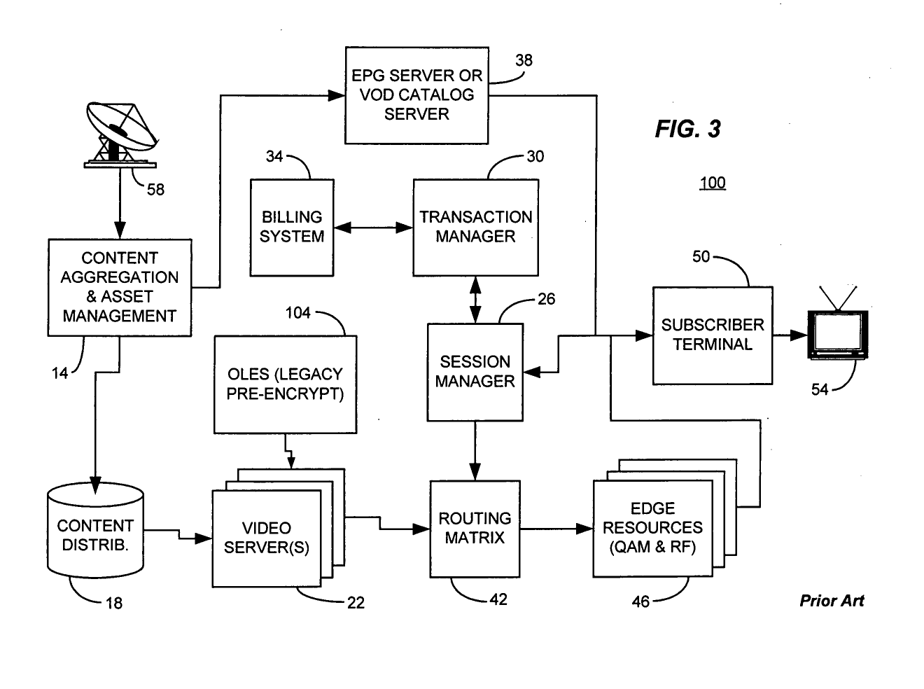

Pre-encrypted VOD systems such as system 100 shown in FIG. 3 can be architecturally similar to clear VOD distribution systems. One difference between the two is that on pre-encrypted systems there is pre-processing of the content prior to storage in the VOD system to provide safekeeping of content during the storage and distribution phases. This pre-processing can be carried out in pre-encryptor 104. Data security is implemented through storage of previously encrypted content within the video server(s) 22. While the clear VOD system contains directly viewable MPEG or other compressed A/V content on the server(s) 22, the pre-encrypted model stores this same content in a form that is only decipherable using a properly entitled subscriber terminal 50.

The pre-encryption process can be performed by the MSO at the time of deployment on the VOD system 100, prior to loading into the storage area network (SAN) used to propagate content to all of the video servers in the MSO's system. Alternatively, the encryption may be performed prior to receipt of the content by the MSO at an external service bureau, content aggregator or by the distributor or studio. In this case, the content is theoretically secured throughout the distribution phase, storage phase and transmission to subscriber for display on an authorized device. The use of pre-encryption prior to distribution of content to the MSO potentially adds to the complexity of entitlement distribution, separate from the content distribution, for installation on the VOD transaction manager 30 to allow bone fide subscribers to decrypt the purchased content. For purposes of this document, content will be considered stored in the VOD video server if it is stored either directly in the VOD video server or indirectly in the VOD video server (i.e., is accessible by the VOD video server).

Many pre-encrypted VOD architectures share one or more of the following common drawbacks:
Additional handling of new content may be needed to perform the pre-encryption prior to loading into the server, either by the MSO or service bureau.
Coordination and/or distribution is required for entitlements matching the access criteria used to encrypt the content stored in the server.
Limited “shelf life” of the encryption keys used to secure the stored content, rendering decryption impossible at a later date.
Incapability of present VOD video servers to load pre-encrypted streams.
Incompatibility of pre-encrypted streams with present methods supporting trick mode play (fast-forward & rewind) on screen.
One common key is used for all sessions accessing a particular program and it remains the same for the duration of time the content is in inventory on the server.
According to MSOs familiar with the subject, pre-encrypted VOD streams are unsupported by conditional access technologies from certain manufacturer(s).

The issue regarding trick play and pre-encryption is based upon the concept that VOD servers 22 currently expect clear content and then subsequently identify the I-frames and store or otherwise segregate them for access in fast-forward or fast rewind playback modes, as described in conjunction with FIG. 2. If the stream is pre-encrypted prior to storage upon the server, it may be difficult or impossible for the server 22 to examine packet payloads to identify I-frames during the process of importation into the server 22 to create trick mode files 78 and 80 or associated indices. Many current systems will not accept streams for importation that are pre-encrypted.

Segregated Storage Pre-Encryption

A segregated storage mechanism can be physically similar to the architecture of the clear VOD distribution system. The content is encrypted in its entirety (100%) and a separate copy of the complete feature is stored for each different conditional access format supported by the MSO. The organization and configuration of the system is such that when a subscriber initiates a session on the server, the stream files for the selected content containing the CA format appropriate to the specific equipment deployed at the subscriber's premises requesting the session are spooled and delivered. This method offers a low system complexity encrypted VOD system but may suffer from some of the same issues common to other pre-encryption topologies, mentioned previously. In addition, a very significant storage penalty (one or more encrypted duplicate copies of the same movie) is incurred.

If one refers to the example movie scenario described above, the same movie using 3.618 GB of storage in the clear VOD state would require an additional 7.236 GBytes to store using segregated pre-encryption supporting two different CA systems.

Changes to the method employed by the VOD system are used for creating dynamic PSI data to implement this architecture supporting multiple CA systems. The VOD system session manager is made aware of which conditional access method is appropriate for a session requested by a specific subscriber. This information is in turn transferred to the video server that has been selected as the source for the session so that the appropriate PSI can be created for the session, including conditional access specific data. The video server is cognizant of the conditional access resources (ECMs) for each program stored on the server and these resources can be dynamically allocated on unique PIDs along with PIDs for the corresponding audio and video data. The PSI generated for each specific session, in addition to indicating the assigned PIDs for A/V, indicate the appropriate CASID, which is unique to each conditional access system provider and the PID assigned for the ECMs associated with the session.

Composite Storage Pre-Encryption

Composite storage is essentially the storage on the video server of a selectively encrypted stream such as a Passage™ processed stream that contains previously encrypted “critical packets” for a plurality (two or more) of independent conditional access systems (i.e., dual selective encrypted). The stream may be prepared identically to the processing of a selectively encrypted broadcast stream as described in the above-referenced pending patent applications, except that the resultant transport stream is recorded to a hard disk or other suitable computer readable storage medium, instead of being sent directly to a QAM modulator for HFC distribution to the requesting subscriber. As with other pre-encryption models, the content can be encrypted by either the MSO at time of deployment on the VOD system, a third party service bureau, by the studios themselves (the latter two cases being prior to receipt of the content by the MSO), or by or under control of other entities.

In this embodiment the small additional overhead in content storage (typically 2%-10% representing “critical packets” that are multiple encypted) is traded for the support of multiple independent CA formats without replication of entire streams. A negative aspect, in addition to those mentioned previously and common to other pre-encryption topologies, is the vulnerability of the prepared selectively encrypted stream to corruption by downstream equipment containing transport remultiplexing functionality that is not specifically designed to maintain the integrity of the selective encryption process applied to the stream.

If one refers to the example movie scenario described above, the same movie using 3.618 GB of storage in the clear VOD state would require approximately 3.690 GBytes to store using composite storage pre-encryption supporting two different CA systems with a critical packet “density” of 2%.

Certain changes to the method employed by the VOD system for creating dynamic PSI data can be used to implement this architecture. The VOD system session manager can be made to be aware of which conditional access method is appropriate for a session requested by a specific subscriber. This information is in turn transferred to the video server that has been selected as the source for the session so that the appropriate PSI can be created for the session, including conditional access specific data. The video server is cognizant of the conditional access resources (ECMs) for each program stored on the server and these can be dynamically allocated on unique PIDs along with PIDs for the corresponding audio and video data. The PSI generated for each specific session, in addition to indicating the assigned PIDs for A/V, can indicate the appropriate CASID, which is unique to each conditional access system provider and the PID assigned for the ECMs associated with the session.

Likewise, the video server dynamically allocates another set of PIDs for the shadow packets associated with the respective audio and video component streams for each session in the manner described in the above-referenced patent applications. This information can be included in the PSI sent in sessions requested by non-legacy clients. In total, eight different PIDs and corresponding data resources are dynamically allocated and managed by the server for each session: PAT (one table common to all sessions, but modified for each), PMT, Primary Video, Primary Audio, Shadow Video, Shadow Audio, Legacy ECM and Alternative ECM. Six of these entities can be stored in the embedded stream and use dynamic PID remapping for each session.

Consider the issue of which device to use in conjunction with performing the legacy encryption of the “critical” packets prior to storage on the VOD video server. If the legacy device is specially designed to process content destined for loading into a VOD video server, it may not accept a selectively encrypted stream at its input. The content format specified for VOD servers often uses a single program transport multiplex containing a single PAT entry, single PMT entry and service components, for one audio and one video stream. The shadow packets added in a composite selectively encrypted transport stream may prove problematic for a legacy VOD pre-encryption device, in certain instances. It is more probable that a device or process (since there are no real time requirements, an off-line process running on a PC or UNIX server may suffice) to process a candidate stream before passing through the legacy pre-encryptor and then post-encryption reconcile to extract only the encrypted “critical” packets for insertion into the VOD video server 22. The same or similar algorithms and techniques for performing this manipulation for selective encryption processing as described in the above-referenced patent applications can be adapted to VOD applications for off-line work.

The VOD server 22 may also be modified to allow introduction of streams having multiple service elements (primary video, primary audio, shadow video, shadow audio) uniquely associated with a Passage™ transport. The present video servers generally only allow one each, primary video and audio, respectively. The quartet of data representing Passage™ processed A/V content should preferably be managed as a indivisible set on the VOD video server 22.

Some additional bandwidth efficiencies may be obtained if, at the edge resources, shadow packets are removed from the composite streams in sessions serving legacy clients. Similarly, in certain embodiments, the edge resources, if selective encryption aware, could reinsert the shadow packets embedded in the stored stream in place of the legacy encrypted packets on the original program PID. These improvements would result in no carriage overhead for support of multiple conditional access systems on a single transport.

Hybrid Composite Storage Pre-Encryption

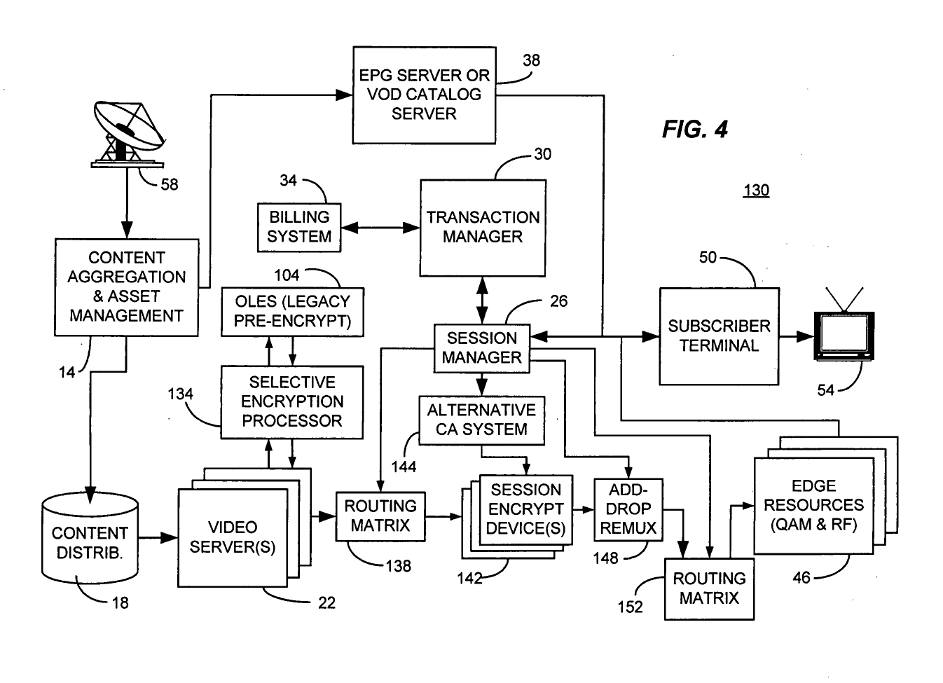

Hybrid composite storage is a variant of the composite storage concept, but incorporates elements of session-based encryption for implementing the alternative conditional access encryption. In this scenario, depicted as system 130 of FIG. 4, the legacy “critical” packets, comprising approximately 2-10% of the total content, are pre-encrypted by the legacy conditional access system 104 using selective encryption technology for managing the process. The selective encryption is managed in selective encryption processor 134. The duplicate copy of “critical” packets, which are located on previously unused PIDs, is left unencrypted. This latter aspect is the departure from the composite storage scenario described above. The composite stream of unencrypted non-critical packets, legacy encrypted “critical” packets on the original service PIDs (e.g., PID A) and an unencrypted, duplicate copy of the “critical” packets on alternate service PIDs (e.g., PID B) is stored on the video server 22 as a single stream.

Therefore, an abbreviated stream of packets might be stored as follows:

| | | | | | | | | | | | |
|---|---|---|---|---|---|---|---|---|---|---|---|
| Clear | Clear | Clear | Clear | Clear | Legacy | Duplicate | Clear | Clear | Clear | Clear | . . . |
| PID A | PID A | PID A | PID A | PID A | Encrypted | Clear | PID A | PID A | PID A | PID A | |
| | | | | | PID A | PID B | | | | | |

Thus, a computer data structure representing digital video content consistent with certain embodiments has a segment of digital video content divided into a plurality of data packets. The data packets are divided into at least three types of data packets as follows: a first type of data packet that is selected according to a selection criterion for encryption; a second type of data packet that is not-selected according the selection criterion; and a third type of data packet that comprises duplicates of the first type of data packets. The first type of data packet are encrypted under a first encryption system, the second type of data packet is unencrypted, and the third type is unencrypted. Such a data structure can be stored on the VOD server 22 or any other suitable computer readable storage medium, and/or transmitted from place to place over any suitable electronic communication medium.

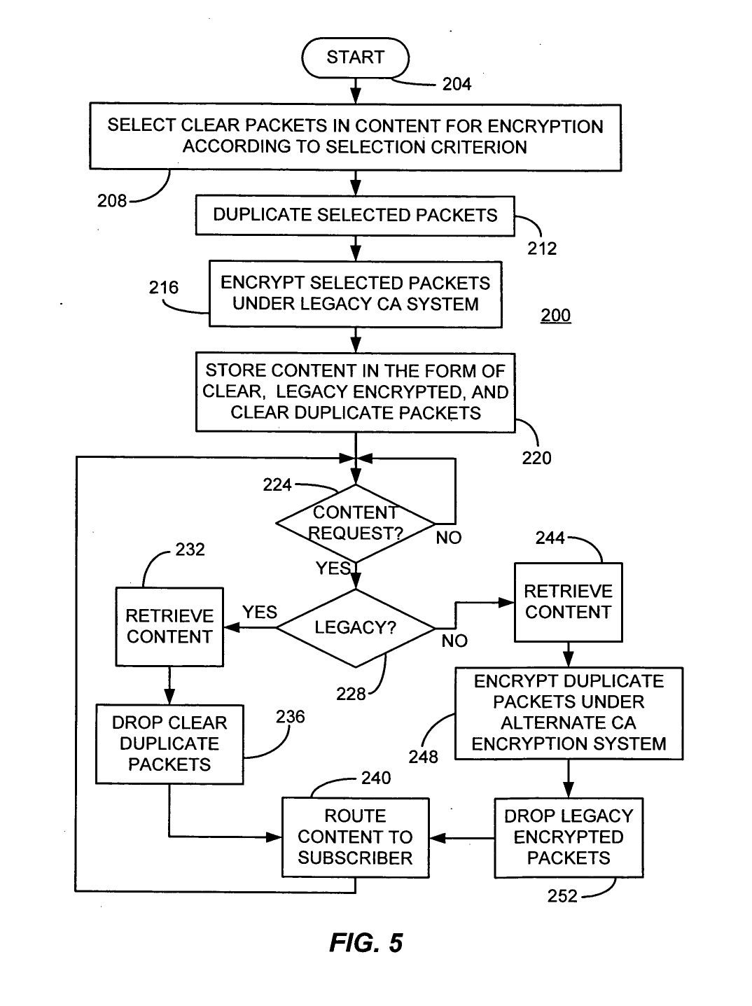

FIG. 5, viewed in conjunction with FIG. 4, depicts one process 200 consistent with certain embodiments for storage and retrieval of content starting at 204. As described above, the clear content is processed at 208 to select packets for encryption using any suitable selective encryption selection criterion such as those described in the above-referenced patent applications or any other suitable selection criterion. Once those packets are selected, they are duplicated at 212 to produce duplicates of the selected packets. At 216, the selected packets are encrypted under the legacy CA encryption system. At this point, the content can be stored as a file or collection of files containing the clear content, the encrypted selected content, and the clear duplicate content at 220.

Upon playback to a subscriber session as a result of a subscriber request at 224, if the session is destined for a legacy STB (represented by subscriber terminal 50) at 228, the existing paradigm for pre-encrypted content is followed and no special action is taken. The content is retrieved from storage at 232. The stream is routed at routing matrix 138 operating under control of session manager 26, through a session encryption device 142 capable of performing encryption using the alternative conditional access system 144, but the session manager 26 does not provision the device to perform encryption on elements of the stream and it is sent directly to the requesting subscriber without further modification. To maintain security of the outgoing stream and to reduce the bandwidth of the session for legacy sessions, the stream is processed through an add-drop remultiplexer 148 and the clear “critical” duplicate content on alternate service PIDs are removed at 236 from the outgoing transport. The output stream is then routed at routing matrix 152 to appropriate edge resources 46 for delivery to the subscriber terminal 50 at 240. In one embodiment, the session encryption device 142 that performs encryption using the alternative conditional access system also contains the add-drop multiplexer capability. Other variations will also occur to those skilled in the art upon consideration of the present teaching.

If, on the other hand, the session is destined for a non-legacy STB (also as represented in this illustration by subscriber terminal 50) at 228, the content is retrieved at 244. The stream is then routed through session encryption device 142 capable of performing encryption using the alternative conditional access system and only the duplicate “critical” packets on alternate service PIDs (previously in the clear) are encrypted at 248 using the alternative conditional access system 144, as provisioned by the session manager. If desired, the legacy encrypted packets can then be dropped at 252 prior to routing the content to the subscriber at 240 as before. Once the content is routed to the subscriber, control returns to 224 for the next content request.

Thus, a multiple selective encryption method for digital content consistent with certain embodiments involves selecting a plurality of packets for encryption according to a selection criterion, to produce selected packets, wherein unselected packets are designated to remain unencrypted. The plurality of selected packets is duplicated to produce duplicate packets, wherein the duplicate packets are unencrypted. The selected packets are encrypted under a first encryption system to produce first encrypted packets. The content is stored by storing the unencrypted unselected packets, the first encrypted packets and the duplicate unencrypted packets.

When a request is received for the content from a subscriber terminal, the process determines if the subscriber terminal is compatible with the first encryption system, and if so retrieves the stored content and sends the content to the subscriber terminal. The duplicate unencrypted packets can be deleted from the content before sending the content to the subscriber terminal.

If the request for the content is received from a subscriber terminal that is compatible with a second encryption system, the stored content is retrieved, the duplicate packets are encrypted under the second encryption system, and the content is sent to the subscriber terminal. The first encrypted packets can be deleted from the content before sending the content to the subscriber terminal.

The above-described processes can be carried out using a programmed processor such as a programmed general purpose computer residing at the cable system headend.

Some additional bandwidth efficiencies may be obtained for these non-legacy sessions, if the edge device is selective encryption aware, by reinserting the shadow packets embedded in the stored stream, now encrypted, in place of the legacy encrypted packets on the original program PID. This improvement would result in no carriage overhead for support of multiple conditional access systems on a single transport. In another embodiment, both the legacy (encrypted) and non-legacy (clear) packets as well as both sets of PSI data can be sent, however, in this case the entire stream would be available in the clear for anyone willing to remap the PIDs.

In certain embodiments, a preprocessor can be used to perform selective encryption of content to be loaded onto the video server. A modified file protocol can be used to allow the video server to import and associate these files. Either the preprocessor or the video server can be designed to perform the indexing. An alternate instantiation could be use to perform all selective encryption pre-processing (e.g., PID mapping and packet duplication) within the VOD video server 22 itself. This could be accomplished by modifying the VOD video server 22 application to add a pre-processor task as a separate executable, called by the VOD video server 22 during the process to prepare content for pre-encryption.

Changes can be implemented to the method employed by the VOD system for creating dynamic PSI data to implement this architecture. The VOD system session manager 26 is made aware of which conditional access method is appropriate for a session requested by a specific subscriber. This information can in turn be transferred to the VOD video server 22 that has been selected as the source for the session so that the appropriate PSI can be created for the session, including conditional access specific data. The VOD video server 22 is cognizant of the conditional access resources (ECMs) for each program stored on the server and these can be dynamically allocated on unique PIDs along with PIDs for the corresponding audio and video data. The PSI generated for each specific session, in addition to indicating the assigned PIDs for A/V, can indicate the appropriate CASID, which is unique to each conditional access system provider and the PID assigned for the ECMs associated with the session.

Likewise, the VOD video server 22 dynamically allocates PIDs for the shadow packets associated with the respective audio and video component streams for each session. This information is included in the PSI sent in sessions requested by non-legacy clients. Just like in the more general composite storage architecture discussed in the previous section, the video server manages multiple resources and PIDs. The hybrid topology reduces the unique entities by one from eight to seven: there is no need for alternative ECM PID or data resource in the stored composite stream. This information will be added later in a downstream device providing the alternative conditional access encryption for those sessions destined for decoding upon a non-legacy client.

In accordance with certain embodiments consistent with the present invention, certain of the functional blocks used to implement the VOD system can be implemented using a programmed processor such as a general purpose computer. One example of such a functional block is the session manager 26. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using a programmed processor executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

In accordance with certain embodiments consistent with the present invention, certain of the functional blocks used to implement the VOD system can be implemented using a programmed processor such as a general purpose computer. One example of such a functional block is the session manager 26. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using a programmed processor executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Thus, a computer readable storage device for storage and retrieval of digital video content, consistent with certain embodiments has at least one computer readable storage medium. A segment of digital video content resides on the computer readable storage medium. The digital video content has a first plurality of packets selected according to a selection criterion, the plurality of packets being encrypted under a first encryption system; a plurality of duplicate packets of the first plurality of packets, wherein the duplicate packets are stored unencrypted; and a plurality of packets that were not selected according to the selection criterion, wherein the plurality of packets that were not selected are stored unencrypted.

The above device can have the first plurality of packets identified by a first set of Packet Identifiers (PIDs). The plurality of duplicate packets can be identified by a second set of PIDs. The plurality of packets that were not selected can be identified by the first set of PIDs. Other variations in PID identifiers is also possible as taught in the above-referenced patent applications.

While certain illustrative embodiments have been described, it is evident that many alternatives, modifications, permutations and variations will become apparent to those skilled in the art in light of the foregoing description.

1. A multiple selective encryption method for digital content, comprising:
selecting a plurality of packets for encryption according to a selection criterion, to produce selected packets, wherein unselected packets are designated to remain unencrypted;
duplicating the plurality of selected packets to produce duplicate packets, wherein the duplicate packets are unencrypted;
encrypting the selected packets under a first encryption system to produce first encrypted packets;
storing the content by storing the unencrypted unselected packets, the first encrypted packets and the duplicate unencrypted packets.

2. The method according to claim 1, further comprising:
receiving a request for the content from a subscriber terminal;
determining that the subscriber terminal is compatible with the first encryption system;
retrieving the stored content; and
sending the content to the subscriber terminal.

3. The method according to claim 2, further comprising deleting the duplicate unencrypted packets from the content before sending the content to the subscriber terminal.

4. The method according to claim 1, further comprising:
receiving a request for the content from a subscriber terminal;
determining that the subscriber terminal is compatible with a second encryption system;
retrieving the stored content;
encrypting the duplicate packets under the second encryption system; and
sending the content to the subscriber terminal.

5. The method according to claim 4, further comprising deleting the first encrypted packets from the content before sending the content to the subscriber terminal.

6. The method according to claim 4, wherein the first encryption system comprises a legacy encryption system, and wherein the second encryption system comprises an alternate CA encryption system.

7. The method according to claim 1, wherein the first encryption system comprises a legacy encryption system.

8. The method according to claim 1, wherein the unselected packets are identified by a first set of Packet Identifiers (PIDs).

9. The method according to claim 8, wherein the first encrypted packets are identified by the first set of PIDs.

10. The method according to claim 8, wherein the duplicate packets are identified by a second set of PIDs.

11. The method according to claim 1, wherein the content is stored on a video server at a cable system headend.

12. A computer readable storage medium storing instructions which, when executed on a programmed processor, carry out a process of:
selecting a plurality of packets for encryption according to a selection criterion, to produce selected packets, wherein unselected packets are designated to remain unencrypted;
duplicating the plurality of selected packets to produce duplicate packets, wherein the duplicate packets are unencrypted;
encrypting the selected packets under a first encryption system to produce a first encrypted packets;
storing the content by storing the unencrypted unselected packets, the first encrypted packets and the duplicate unencrypted packets.

13. The method according to claim 12, further comprising:
receiving a request for the content from a subscriber terminal;
determining that the subscriber terminal is compatible with the first encryption system;
retrieving the stored content; and
sending the content to the subscriber terminal.

14. The method according to claim 12, further comprising:
receiving a request for the content from a subscriber terminal;
determining that the subscriber terminal is compatible with a second encryption system;
retrieving the stored content;
encrypting the duplicate packets under the second encryption system; and
sending the content to the subscriber terminal.

15. A computer readable storage device for storage and retrieval of digital video content, comprising:
at least one computer readable storage medium;
a segment of digital video content residing on the computer readable storage medium, the digital video content comprising:
a first plurality of packets selected according to a selection criterion, the plurality of packets being encrypted under a first encryption system;
a plurality of duplicate packets of the first plurality of packets, wherein the duplicate packets are stored unencrypted; and
a plurality of packets that were not selected according to the selection criterion, wherein the plurality of packets that were not selected are stored unencrypted.

16. The device according to claim 15, wherein:
the first plurality of packets are identified by a first set of Packet Identifiers (PIDs);
the plurality of duplicate packets being identified by a second set of PIDs; and
the plurality of packets that were not selected being identified by the first set of PIDs.

17. The device according to claim 15, wherein the digital video content comprises MPEG encoded digital video content.

18. The device according to claim 15, wherein the first encryption system comprises a legacy encryption system.

19. The device according the claim 15, wherein the computer readable storage medium comprises a set of video server disk drives.

20. The device according to claim 15, residing at a video on demand server at a cable system headend.

21. A computer data structure representing digital video content, comprising in combination:
a segment of digital video content divided into a plurality of data packets;
the data packets being divided into at least three types of data packets as follows:
a first type of data packet that is selected according to a selection criterion for encryption;
a second type of data packet that is not-selected according the selection criterion; and
a third type of data packet that comprises duplicates of the first type of data packets,
wherein, the first type of data packet are encrypted under a first encryption system, the second type of data packet is unencrypted, and the third type is unencrypted.

22. The computer data structure according to claim 21, wherein the data structure is stored on a computer readable storage medium.

23. The computer data structure according the claim 22, wherein the computer readable storage medium comprises a set of video server disk drives.

24. The computer data structure according to claim 22, wherein the computer readable storage medium resides at a video on demand server at a cable system headend.

25. The computer data structure according to claim 21, wherein the first type of data packets are identified by a first set of Packet Identifiers (PIDs).

26. The computer data structure according to claim 25, wherein the third type of data packets are identified by a second set of Packet Identifiers (PIDs).

27. The computer data structure according to claim 21, wherein the digital video content comprises MPEG encoded digital video content.

28. The computer data structure according to claim 21, wherein the first encryption system comprises a legacy encryption system.

29. The computer data structure according to claim 21, wherein the data structure is transported over an electronic communication medium medium.
